(19) United States
(12) Patent Application Publication
(10) Pub. No.: US 2008/0157618 A1
(43) Pub. Date: Jul. 3, 2008

(54) Axial induction motor structure

(75) Inventors: Win-Haw Chen, Taipei (TW); Chen-Yueh Chang, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/645,500

(22) Filed: Dec. 27, 2006

(51) Int. Cl. H02K 21/12

(52) U.S. Cl. 310/156.32; 310/267

(57) ABSTRACT

An axial induction motor structure including a case, a rotor, and a stator is provided. The rotor is pivoted on the case by a shaft and includes a ring-magnetic section. The ring-magnetic section is composed of a plurality of magnet-conducting parts. The adjacent magnet-conducting parts have different magnetic polarities. The stator and the rotor are co-axially stacked. In addition, the stator has a plurality of magnet-generating parts corresponding to the magnet-conducting parts. When the magnet-generating parts are conducted, the magnet-generating parts generate the magnetic polarities different from those of the magnet-conducting parts periodically, such that the rotor is rotated. Thus, the radial length of the axial induction motor is reduced so as to decrease the overall volume and to reduce production cost.

### BACKGROUND OF THE INVENTION

1. Field of Invention

The present invention relates to an axial induction motor structure, and more particularly, to an axial induction motor structure with a stator and a rotor axially stacked.

2. Related Art

In a conventional electromagnetic induction motor structure, copper wires are wound around a silicon steel sheet for appropriate turns to form a coil. The coil is disposed at the inside edge of a case, and a rotor passes through the center of the coil. When the coil is powered, a magnetic field is generated and the rotor is driven to rotate by electromagnetic induction, thereby outputting the torque kinetic energy for the rotation of the motor. Current electromagnetic motors mainly include inner-stator outer-rotor type, outer-stator inner-rotor type, and external polarity motors. However, as most of the motors are inducted to rotate by radial electromagnetic interaction forces, radial space is occupied, so that the specification (size) of fans and pumps and working mechanisms such as configurations and shapes are limited. Moreover, as the winding of the coils of these electromagnetic induction motors is complicated, the process efficiency is low and the failure rate is high. In addition, the overall motor structure is heavy in weight and large in volume, and has a high cost. Therefore, these motors in use cannot meet the light and small requirements, and are not economical.

Furthermore, it is not only the modern trend but also the future direction for the motors to have a miniaturized size and high performance. It has been found in reports in magazines that the production value of microsystem products in the precise and miniature molding field grows progressively year by year. The microsystem products include 21 types of products, such as pickup heads of optical drives or magnetic disk drives, inkjet heads of printers, pressure sensors, and micro motors. As far as the growth rate is concerned, the growth rate of thin motors has achieved about 50 times, which is the highest among all microsystem products.

### SUMMARY OF THE INVENTION

In view of the aforementioned problems of the conventional art, the present invention provides an axial induction motor structure to solve the problem that the size of the working mechanism of an electromagnetic induction motor is limited because the radial space is occupied, and to overcome the defect of large volume and high cost.

To achieve the aforementioned object, the present invention provides an axial induction motor structure, which includes a case, a rotor, and a stator. The rotor is pivoted on the case by a shaft and includes a ring-magnetic section. The ring-magnetic section is composed of a plurality of magnet-conducting parts. The adjacent magnet-conducting parts have different magnetic polarities. The stator and the rotor are co-axially stacked. In addition, the stator has a plurality of magnet-generating parts corresponding to the magnet-conducting parts. When the magnet-generating parts are conducted, the magnet-generating parts generate the magnetic polarities different from those of the magnet-conducting parts periodically, such that the rotor is rotated.

The axial induction motor structure of the present invention is an implementation of a thin motor which is one type of the micro motors. The present invention realizes a miniaturized and high-performance motor structure. As the size of the working mechanism is not limited by the radial space, higher transmission efficiency is obtained relatively, and the cost is reduced. Therefore, the present invention is applicable to many precise and miniature products, and expands the application scope of the entire precise and miniature products on the basis of the miniaturized motor.

To make the object, structure, features, and functions of the present invention more apparent, the present invention is illustrated below in detail with reference to the embodiments and the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the axial induction motor structure of the present invention;

FIG. 2 is a schematic sectional view of the axial induction motor structure of the present invention; and

FIG. 3 is a schematic sectional view of the arrangement of the stator and the rotor of the axial induction motor structure of the present invention.

### DETAILED DESCRIPTION OF THE INVENTION

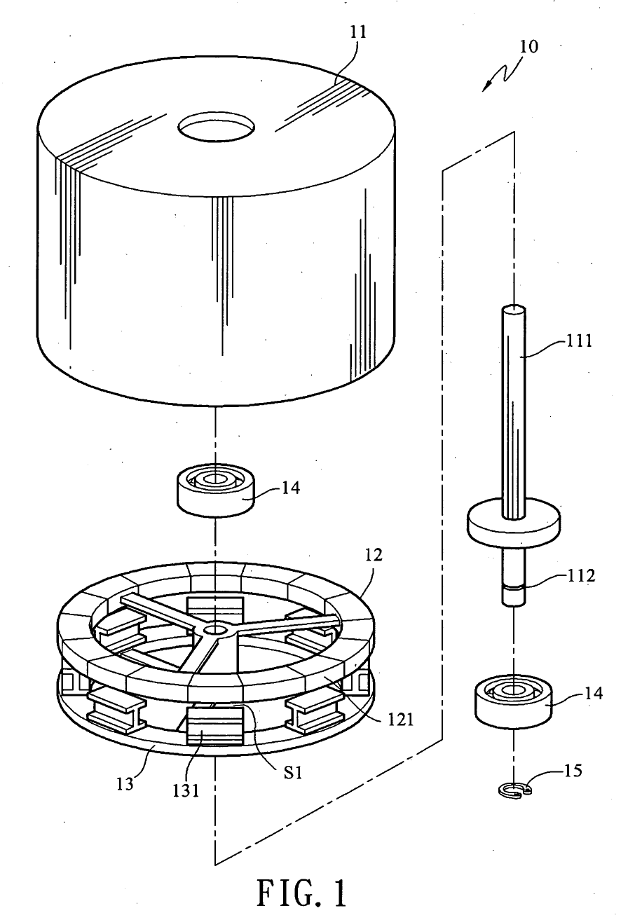

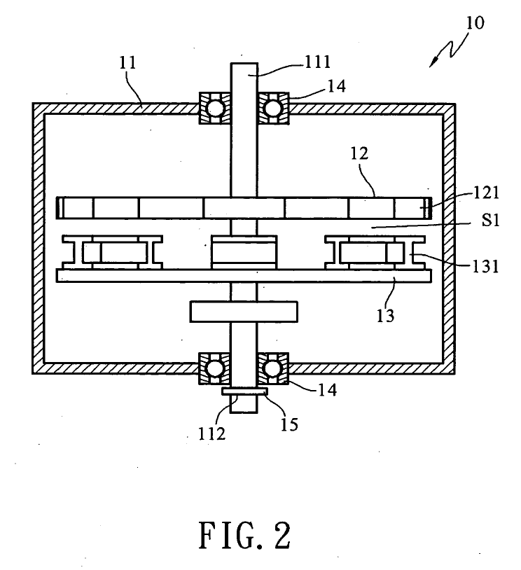

Firstly, referring to FIGS. 1 and 2, the present invention relates to an axial induction motor structure. The axial induction motor structure 10 includes a case 11, a rotor 12, and a stator 13. A shaft 111 is pivoted on the case 11, and the rotor 12 is fixed to the shaft 111. Moreover, the rotor 12 includes a ring-magnetic section which is composed of a plurality of magnet-conducting parts 121. Adjacent magnet-conducting parts 121 have different magnetic polarities, i.e., adjacent magnet-conducting parts 121 form a ring with the arrangement of a positive pole and a negative pole, or the adjacent magnet-conducting parts 121 form a ring with the arrangement of a negative pole and a positive pole. Furthermore, the stator 13 is fixed in the case 11, and is co-axially stacked with the rotor 12, and includes a plurality of magnet-generating parts 131 corresponding to the magnet-conducting parts 121. A gap S1 exists between the magnet-conducting parts 121 and the magnet-generating parts 131. When the magnet-generating parts 131 of the stator 13 are conducted, the magnet-generating parts 131 generate the magnetic polarities different from the magnetic polarities of the corresponding magnet-conducting parts 121 of the rotor 12.

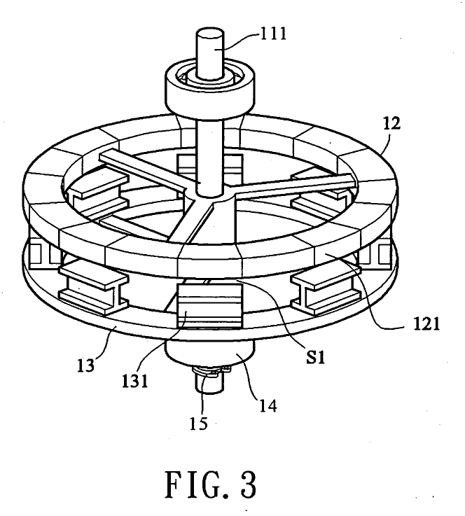

Then, referring to FIGS. 1, 2, and 3, the present invention relates to an axial induction motor structure. The magnet-generating parts 131 of the stator 13 of the axial induction motor structure 10 are composed of a plurality of poles wound with coils, and the rotor 12 is a magnet material having multiple magnetic segments. Moreover, the axial induction motor structure 10 further includes two bearings 14 and a C-shaped ring 15. The bearings 14 are fixed between two ends of the shaft 111 and the case respectively so as to grip the shaft to rotate in-between. A groove 112 is further carved in the surface of the shaft 111, such that the C-shaped ring 15 is fixed in the groove 112, and closely contacts the bearings 14, thereby preventing the shaft 111 from sliding out of the case 11. When the magnet-generating parts 131 of the stator 13 are conducted, the magnet-generating parts 131 generate the magnetic polarities different from the magnetic polarities of the magnet-conducting parts 121 of the rotor 12. In more detail, as shown in FIG. 3, when the magnet-generating parts 131 of the stator 13 are opposite to the magnet-conducting parts 121 of the rotor 12 at the first time point, the magnet-generating parts 131 and the magnet-conducting parts 121 generate different magnetic polarities, so a mutual attraction is generated. While at the second time point, as the adjacent magnet-conducting parts 121 have different magnetic polarities, the adjacent magnet-conducting parts 121 and magnet-generating parts 131 have the same magnetic polarities, the magnet-conducting parts 121 and the magnet-generating parts 131 will have a mutual repulsion, thus generating a horizontal pushing force to drive the rotor 12 to rotate.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An axial induction motor structure, comprising:
a case having a shaft pivoted on the case;
a rotor fixed to the shaft and having a ring-magnetic section, wherein the ring-magnetic section includes a plurality of magnet-conducting parts, and adjacent magnet-conducting parts have different magnetic polarities; and
a stator fixed to the case and co-axially stacked with the rotor, wherein the stator includes a plurality of magnet-generating parts corresponding to the magnet-conducting parts, when the magnet-generating parts are conducted, the magnet-generating parts generate magnetic polarities different from the magnetic polarities of the corresponding magnet-conducting parts.

2. The axial induction motor structure as claimed in claim 1, wherein the magnet-generating parts of the stator comprise of a plurality of poles wound with coils.

3. The axial induction motor structure as claimed in claim 1, wherein the rotor is a magnet material having multiple magnetic segments.

4. The axial induction motor structure as claimed in claim 1, wherein the axial induction motor structure comprises two bearings fixed between two ends of the shaft and the case respectively so as to grip the shaft to rotate in-between.

5. The axial induction motor structure as claimed in claim 4, wherein the axial induction motor structure further comprises a C-shaped ring, and a groove is further carved in a surface of the shaft to fix the C-shaped ring in the groove and closely contact C-shaped ring with the bearings.

6. The axial induction motor structure as claimed in claim 1, wherein a gap exists between the magnet-conducting parts and the magnet-generating parts.
